(19) United States
(12) Patent Application Publication
(10) Pub. No.: US 2010/0160032 A1
(43) Pub. Date: Jun. 24, 2010

(54) Methods and Apparatus for Self Service Dispensing and Redemption of Gaming Chips

(75) Inventor: Grant Charles Paton, Dundee (GB)

Correspondence Address: PAUL W. MARTIN, NCR CORPORATION, LAW DEPT., 3097 Satellite Blvd., 2nd Floor, Duluth, GA, 30096, US

(73) Assignee: NCR Corporation, Dayton, OH (US)

(21) Appl. No.: 12/341,117

(22) Filed: Dec. 22, 2008

(51) Int. Cl. G06F 17/00

(52) U.S. Cl. 463/25

(57) ABSTRACT

Systems and techniques for self service transaction processing for gaming chips using radiofrequency (RFID) verification and authentication. A self service terminal receives inputs and selections from a patron purchasing gaming chips and dispenses chips conforming to the patron's purchase request. As chips are being dispensed, RFID information is read from each chip and compared against centrally stored information for the chip to confirm the validity, identity, and value of the chip. The terminal also receives deposits of chips for redemption and reads RFID information from each chip submitted for redemption, comparing the information read from the chip against centrally stored information before accepting the chip for redemption.

### FIELD OF THE INVENTION

The present invention relates generally to improvements related to self service dispensing and redemption mechanisms, such as those utilized for issuing and receiving gaming chips containing embedded radio frequency identification (RFID) devices.

### BACKGROUND OF THE INVENTION

Radio frequency identification (REID) devices, such as RFID tags and readers have produced great advances in tracking and identification of objects, allowing individual objects to be uniquely identified, even if the objects appear identical. An RFID tag can be affixed to or embedded in an object, and the tag can be interrogated by an RFID reader when desired. The tag responds to the interrogation with a response providing information stored in the tag. Such interrogation of a tag may be performed by a reader, or by a succession of readers.

Gaming chips are widely used as a cash substitute in gaming transactions, providing convenient handling and sorting in the conduct of such transactions. The chips issued by a gaming establishment are typically all of the same size and weight, and chips assigned different values are distinguished by color and markings. Gaming enterprises are adapting more and more to the use of chips having embedded RFID tags, because these tags allow individual identification and tracking of each chip. Such tags allow for tracking of play and of transactions involving chips. The use of chips with embedded tags allows chip to be tracked in a variety of ways. For example, a chip may be identified at issuance to a player at a table or at a casino cage. Chips won or lost by a player can be identified as they are passed to the player or returned to the table. Chips redeemed by a player can be identified as they are returned to the casino cage. Movement of chips can be tracked as the chips are transported by players or by casino personnel.

Issuance and redemption of chips, including RFID embedded chips, is generally accomplished through manual transactions. An employee of a gaming establishment who issues or redeems a gaming chip verifies the authenticity and denomination of the chip. Such verification may include the use by the employee of RFID equipment to identify the chip and to capture tracking information relating to the disposition of the chip. The need for such employee assisted operations incurs labor costs and typically results in lines at busy times as patrons wait to redeem their chips.

### SUMMARY OF THE INVENTION

Chips issued by a gaming establishment are typically of the same size and weight across numerous denominations. The identical size and weight of chips, combined with the substantial value that may be assigned to chips, has rendered it difficult to provide sufficiently reliable mechanisms for self service transactions involving gaining chips.

Among its several aspects, the present invention recognizes that the information provided by RFID devices embedded in gaming chips can be used in self-service applications to provide for positive identification and validation of chips that are to be dispensed or redeemed. Considerations taken into account by the invention are the advantages of identifying each chip being dispensed or redeemed, the advantages of associating each chip with the purchaser to the extent acceptable to or desired by the purchaser, and the importance of preventing acceptance of counterfeit chips, and similar considerations.

A self service terminal according to an aspect of the present invention includes facilities for conducting financial transactions, such as a cash acceptor or a financial card reader, or other desired mechanisms for receiving instruments of value or financial information. The terminal further provides a user interface for conducting dispensing and redemption transactions, and a chip identification module for identifying each chip dispensed and submitted for redemption. The chip identification module reads information from and writes information to chips as needed to identify each chip and to prevent counterfeiting of chips. The terminal further provides a communication interface with a centralized facility, such as a central server accessible over a preferably secure network, in order to transmit and retrieve appropriate information relating to chips dispensed and submitted for redemption.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a self service terminal according to an aspect of the present invention;

FIG. 2 illustrates a chip identification module according to an aspect of the present invention; and

FIG. 3 illustrates a process of dispensing and redeeming chips according to an aspect of the present invention.

### DETAILED DESCRIPTION

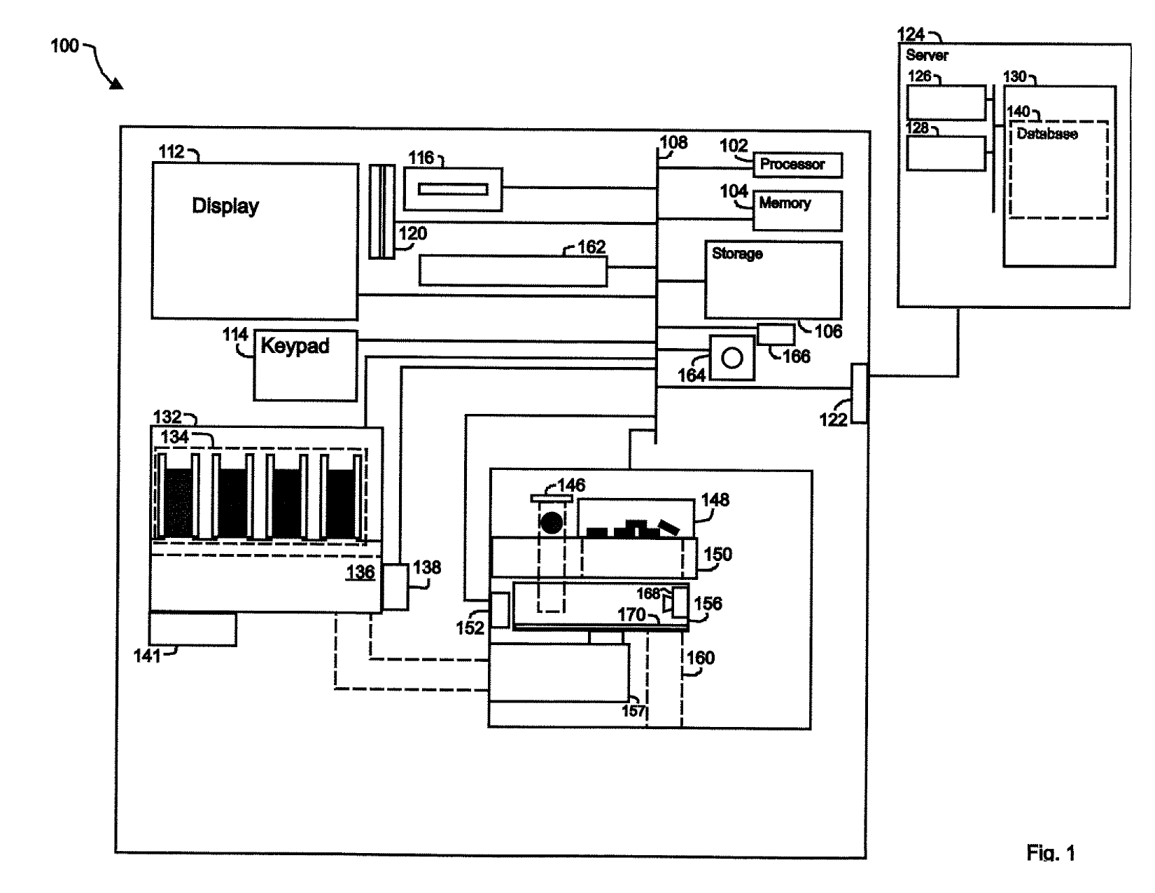

FIG. 1 illustrates a self service terminal 100 according to an aspect of the present invention. The terminal 100 may operate under the control of a processor 102, employing computer readable media such as memory 104 and long term storage 106, all communicating over a bus 108. The terminal further comprises a user interface 110, which may suitably comprise a display screen 112, such as an LCD touch screen, and a keypad 114. The terminal 100 further comprises a note acceptor 116 for receiving, validating, and crediting cash deposits. The terminal 100 additionally comprises a magnetic stripe reader 120, for reading a financial card such as a debit card or automated teller machine (ATM) card, and an external interface, such as a network interface 122, for communicating with a central server 124. The server suitably comprises a processor 126, and computer readable media such as memory 128 and long term storage 130.

The terminal 100 further comprises a storage compartment 132 for storing gaming chips, and a delivery mechanism 134 for selecting and delivering chips in the desired quantity and denominations. In one suitable configuration, the storage compartment 132 holds the chips in stacks of each denomination available to be delivered, with the stacks being secured within the delivery mechanism 134. The delivery mechanism 134 operates to release the appropriate number of chips of each denomination in accordance with the transaction, with the chips falling into a delivery compartment 136 for delivery to the user. As each chip is being delivered to the delivery compartment 136, it is read by a combination RFID reader/writer 138, or alternatively the chips are read once they have been deposited in the delivery compartment. A reader/writer 138 is discussed here to provide capability for writing data to chips employing programmable RFID tags, but it will be recognized that various aspects of the present invention may be practiced using an RFID reader without writing capabilities. Preferably, each chip stores at least a unique identifier, and may also store a value indicator, an authenticator code, and whatever additional information is desired. As described below in greater detail, chips may include RFID tags having a programmable portion.

In one embodiment of the invention, a chip can be given a unique authenticator code that must be recognized as valid before value is given for the chip. Such an authenticator code may be associated with an identifier for the chip, and the identifier and the authenticator code may both be stored in a centralized location, such as in a database 140 stored on the server 124. A chip's identifier and authenticator code may be read from the chip, and both the identifier and the authenticator code must be matched to corresponding values stored in the centralized location before the chip is accepted for redemption. Once a chip has been accepted for redemption, the authenticator code associated with the chip's identifier may be invalidated, so that a new authenticator code must be written to the chip before the chip can be redeemed again.

Once the chip has been read, the RFID reader 138 passes the information received from the chip to the memory 104 for use by the processor 102. The processor 102 examines a chip database 140, suitably hosted by the server 124, to authenticate the chip. The database 140 may suitably store information for each chip, including identifier, value, authenticator code value, and additional information, such as the identities and locations of the various readers that have encountered the chip. A gaming establishment may dispose readers at numerous locations, such as at the entrance, at the various tables and machines at which chips may be used, at the casino cage, and at various other locations. Information for each chip is suitably stored in the database 140, whenever a chip is transferred to a patron.

If chips employ stored authenticator codes, a chip will be assigned a valid authenticator code at some point before the chip is transfered to a patron. However, the point at which such an assignment is performed may vary according to the needs of the establishment. For example, in the case of the terminal 100 described here, a chip may be assigned a valid authenticator code before loading into the terminal, or the assignment may be performed within the terminal 100 as the chip is dispensed to a user. For example, a number of chips may be deposited in the compartment 136 in order to fulfill a transaction, and each such chip may be loaded with a valid authenticator code before delivery to the user. Once the correct number of chips has been delivered to the compartment 136 and these chips have been validated, the compartment may be opened and the user allowed to collect the chips. If an incorrect number or value of chips has been deposited in the compartment 136, the chips may be diverted to a rejection chamber and a new delivery attempt may be made. If it is not desired to make a second attempt, or if an excessive number of failed attempts has occurred, appropriate action may be taken, such as reversing the transaction or summoning an attendant.

The terminal 100 also includes a chip acceptor 142. The chip acceptor 142 may suitably comprise a slot 146 for inserting chips one at a time and a bin 148 for depositing a larger number of chips. The acceptor 142 also comprises a control mechanism 150 for controlling and directing the movement of chips so that proper counting and identification can be performed. The acceptor 142 further employs an RFID reader 152 to identify chips. Chips deposited into the receptacle 144 are managed in any of a number of ways so as to facilitate reading and identification of the chips. To take one example, chips may be directed past the reader 152 so that each chip is brought within range of the reader 146 for a sufficient time for the reader 152 to interrogate the chip and receive a response. The operation of the control mechanism 150 may be directed by the processor 102, with the processor directing the control mechanism 150 to stop the movement of a chip within range of the reader 152 and release the chip only when the reader 152 has performed all necessary operations on the chip. If reading of the chip is successful, the chip may be released to a holding bin 156. If reading of the chip fails, the chip may be diverted to a return chute 148 for delivery to the user.

To take another example, user may simply deposit one or more chips into the receptacle 138, and all deposited chips maybe directed into the holding bin 156 and held while the reader 152 interrogates the chips. Many readers are capable of interrogating a number of tags within range using techniques known in the art. Once the chips in the bin 156 have been read, the receptacle 148 may release the chips into a storage compartment 157. In one exemplary embodiment, chips may be counted by one or more electronic or mechanical counters as they move to the bin 156, so that the number of chips present in the bin 156 is known. The number of chips counted may then be matched against the number of chips identified through interrogation by the reader 152. By way of example, the reader 152 may be disposed alongside the chip chute and read chips as they pass down the chute. If the number of chips counted does not match the number of chips responding to interrogation, the chips are released to a diversion chute 160 for retrieval by the customer and not accepted for redemption.

If the delivery of chips to the reader 152 is to be conducted in such a way that only one chip at a time is within range, each chip may be delivered to a predetermined position adjacent the reader 152. When the chip is in the predetermined position, the reader 152 may be activated so as to issue an interrogation signal. The reader 152 receives a response from the chip and receives appropriate information. The information received may suitably include chip identifier, chip denomination, authenticator code, and other appropriate information. The information received by the reader 152 is passed to the memory 104 for examination by the processor 102. The processor 102 compares the data received against corresponding data stored in the database 140. In order for a chip to be accepted for redemption, the information stored in the database 140 must match the information received from the chip. The identifier read from the chip must appear in the database 140 as expected, and all other data read from the chip must be present in the database, such as the denomination and any authenticator code. In addition, the authenticator code, if used, must indicate that the chip is valid for redemption.

If the data read from the chip corresponds to the data stored in the database 140, the chip is valid and the chip is accepted for redemption. Once the chip has been accepted for redemption, appropriate credit is issued. For example, currency may be dispensed through a currency dispenser 162, a user may be allowed to reload a prepaid debit card, a user's financial account may be credited, or any other appropriate mechanism for furnishing payment to the user may be employed.

Once a chip has been accepted for redemption, the chip's authenticator code may be invalidated. Such invalidation may be accomplished, for example, by removing the authenticator code from the database 140, by adding an invalidation marker to the database entry for the accepted chip, or by any other suitable means. Such a procedure provides added security against redemption of counterfeit chips. If a counterfeiter copies a chip that he or she has received legitimately so that the counterfeit includes an exact copy of the information stored in the RFID tag in the genuine chip, the copy will include the chip identifier and the authenticator code. The authenticator code, however, is only valid until the chip is redeemed, and if the counterfeit chip is redeemed and its counterfeit nature is not detected at the time of redemption, the genuine chip will have an invalid authenticator code because the authenticator code will be invalidated at the redemption of the genuine chip. Thus, if the genuine chip is submitted after the counterfeit has been redeemed, the fact that a chip with the same identifier and authenticator code has been redeemed can be noted. The chip will not be accepted for automatic redemption and if it submitted for employee assisted redemption, the patron can be questioned about the submission of the chip. Further security may be provided by capturing an image of a patron, for example, using a camera 164, or using an RFID reader 166 to capture patron information from an RFID card that may be issued by the gaming establishment to the patron. Such patron information can be associated with questionable transactions and used in investigations, and knowledge of the presence of such measures may discourage questionable transactions.

Additional security measures may be employed to supplement the security provided by the RFID information. For example, the acceptor 142 may include a camera 168 to capture an image of each chip as it is deposited. Gaming chips have characteristic designs and colors, as well as other visible security indicia. The design, colors, and other indicia exhibited by a chip indicate the gaming establishment issuing the chip and the denomination of the chip, and provide indications that the chip is authentic. Production of chips is tightly controlled and the visual elements of chips are difficult to duplicate. Therefore, capturing and analyzing an image of a chip provides useful information that can be correlated against RFID information read from the chip. Using a combination of RFID information and visual information helps provide a check against counterfeiting of either the visual aspects of the chip or duplication of the RFID information of a chip, because both aspects must be successfully duplicated in order to produce a usable counterfeit. Similarly, the bin 156, or other suitable element of the acceptor 142, may include a scale, such as the scale 170, to provide weight information for use in validating the chips.

If desired, the terminal 100 may act to dispense chips that have been deposited, rather than requiring deposited chips to be emptied and new chips to be loaded. The storage compartment 157 may include elements allowing the compartment 157 to sort chips as they are received and to deliver them to the storage compartment 132 in proper order for dispensing. As each chip is delivered, appropriate logging is performed using identifier and value information stored in the chip, and all needed steps are taken to insure that the chip will be valid when dispensed.

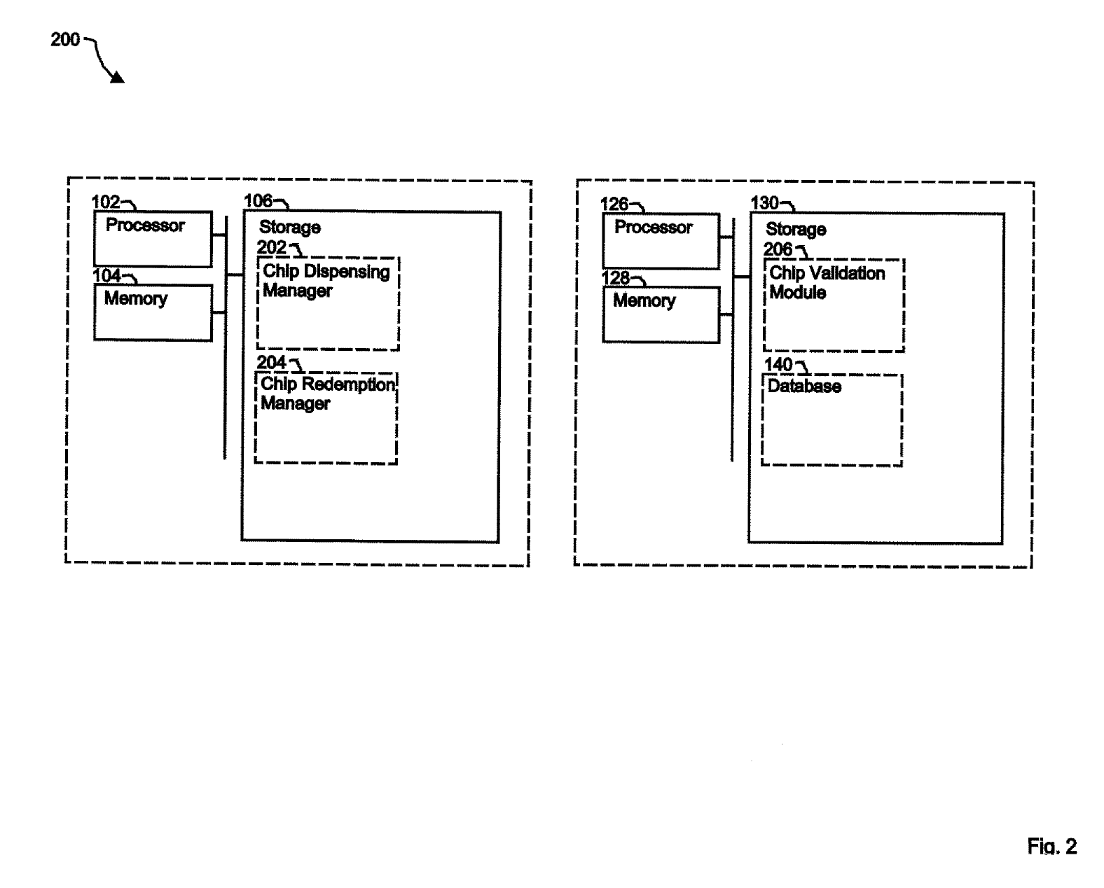

FIG. 2 illustrates additional details of selected data processing elements of the terminal 100 and the server 124, specifically, the processor 102, memory 104, and long term storage 106 of the terminal 100, and the processor 126, memory 128, and long term storage 130 of the server 124, showing the various data and programming used to secure, identify, and otherwise manage chip dispensing and redemption The terminal 100 may suitably employ a chip dispensing manager 202 and a chip redemption manager 204, suitably operating as software stored in the long term storage 108 and transferred to memory as needed for execution by the processor 104 The chip dispensing manager 202 and the chip redemption manager 204 receive information from the reader 152 and the camera 162, and both are capable of directing information to be written to chips using the reader 152. The chip dispensing manager 202 and the chip redemption manager 204 also receive information from the server 124, and communicate information to the server 124 to be used in controlling chip security for the terminal 100 and the gaming establishment in general. The server 124 stores the chip database 140, which is suitably stored in the long term storage 130 for transfer to the memory 128 as needed for use by operations conducted by the processor 126. Such operations include retrieval of information in order to respond to inquiries from terminals such as the terminal 100 and other similar terminals, staff assisted chip distribution and redemption locations, chip storage and management locations, and other locations and facilities where management of chips is carried out. The server 124 may suitably employ a chip validation module 206, which operates to authenticate chips submitted for redemption and to insure the validity of chips dispensed or otherwise transferred to patrons. In transactions or inquiries involving a chip, the chip validation module 206 examines the database 140 to insure that data stored on the chip matches corresponding entries in the database 140, and makes appropriate entries in the database to designate chips as valid or invalid. The chip validation module 206 also responds to queries by indicating the validity or invalidity of a chip under consideration.

The chip dispensing manager 202 operates the control mechanism 136 and the reader 138 in order to deliver chips to a patron as needed. The chip dispensing manager 202 suitably responds to a request to initiate a transaction to satisfy a request for chips by opening an interface for submission of patron financial information or deposit of cash by the patron, and acceptance of a request for chips in the amount desired and corresponding to the cash deposited or financial information submitted. Upon validation of deposit or submission of cash or instruments sufficient for the purchase of the desired chips, the chip dispensing manager 202 operates to dispense valid chips in the amount and denominations desired. The chip dispensing manager 202 directs the control mechanism 134 to release chips of appropriate denominations to the bin 136. As the chips are released to the bin 136, the RFID information stored in each chip is read by the reader 138. Depending on the desired operation of the terminal 100, reading may be performed on each chip as it is released, or each chip may be read once the chips have been delivered to the bin 136. The chip dispensing manager 202 communicates with the chip validation manager 204 operating on the server 124 to insure that the chips are of the proper denominations and that the entry in the database 140 for each chip indicates that the chip is valid. Depending on the management of chips in the establishment, all chips loaded into the terminal 100 for dispensing may be valid, in which case a valid authenticator code for the chip is stored in the database 140 at the time the chip is loaded into the terminal or before, with the authenticator code corresponding to an authenticator code stored on the chip. Alternatively, if chips are to be stored in the terminal 100 in an invalid state, for example, to reduce incentives to break into the terminal 100 to steal chips, a valid authenticator code may be written to each chip Just before dispensing. Such an approach can be advantageous because it allows the placement of a terminal in a less secure environment, such as an airline terminal, and also allows for a less robust construction than is normally used for securing and dispensing valuable articles.

If this is the case, the reader 138 writes a valid authenticator code to each chip that is to be delivered, and this authenticator code is stored in the chip's entry in the database 140. Once all the chips to be delivered have been confirmed as correct and valid, they are delivered to the bin 141 for retrieval by the patron.

When a patron has indicated that chips are to be redeemed, for example, by making an appropriate entry using the display screen 112 or the keypad 114, the chip redemption manager 204 is invoked. The patron deposits chips using the slot 146, the bin 150, or both, and the chip redemption manager 204 operates the control mechanism 150 to manage delivery of chips to the bin 150. As chips are being delivered to the bin 150, or once the chips have been delivered to the bin 150, they are validated. In order to validate a chip, the chip redemption manager 204 invokes the reader 152 in order to read RFID information from each chip that is to be redeemed. The chip redemption manager 204 also communicates with the server 124 to invoke the validation manager 206, in order to determine the identity, denomination, and validity of each chip that has been submitted for redemption. Such a determination includes using an identifier stored in each chip to locate in the database 140 a record corresponding to the identifier, and to examine the record for denomination information and an authenticator code and to compare the denomination and authenticator code read from the database 140 against corresponding information stored in the chip. If the information in the database 140 matches the information stored in the chip, and if the authenticator code stored in the database 140 is a valid authenticator code, the chip is valid and may be redeemed. If all chips deposited in the bin 156 are valid, the chips are then transferred to the storage compartment 157. Appropriate value is given to the patron, for example, by loading a stored value card submitted by the patron, by making an appropriate deposit to the patron's financial account, or by dispensing cash. The authenticator code stored in the chip is then invalidated, for example, by invalidating the code associated with the chip identifier in the database 140.

If one or more of the chips in the bin 156 is invalid, or cannot be identified with sufficient assurance, the chip is not redeemed and is returned to the patron. In cases in which a group of chips are placed in the bin 156 before redemption, all chips may be returned to the patron, for example, through the chute 160. If only one chip is being examined for redemption at a time, or if other mechanisms exist to identify and retrieve invalid chips, the invalid chips can be returned while the valid chips are redeemed. Appropriate information is provided to the patron explaining that one or more chips have been rejected and making alternative suggestions for redemption If all chips are returned to the patron, the patron may be given information or suggestions for redeeming valid chips, such as inserting chips for redemption one at a time, so as to avoid ambiguity between valid and invalid chips.

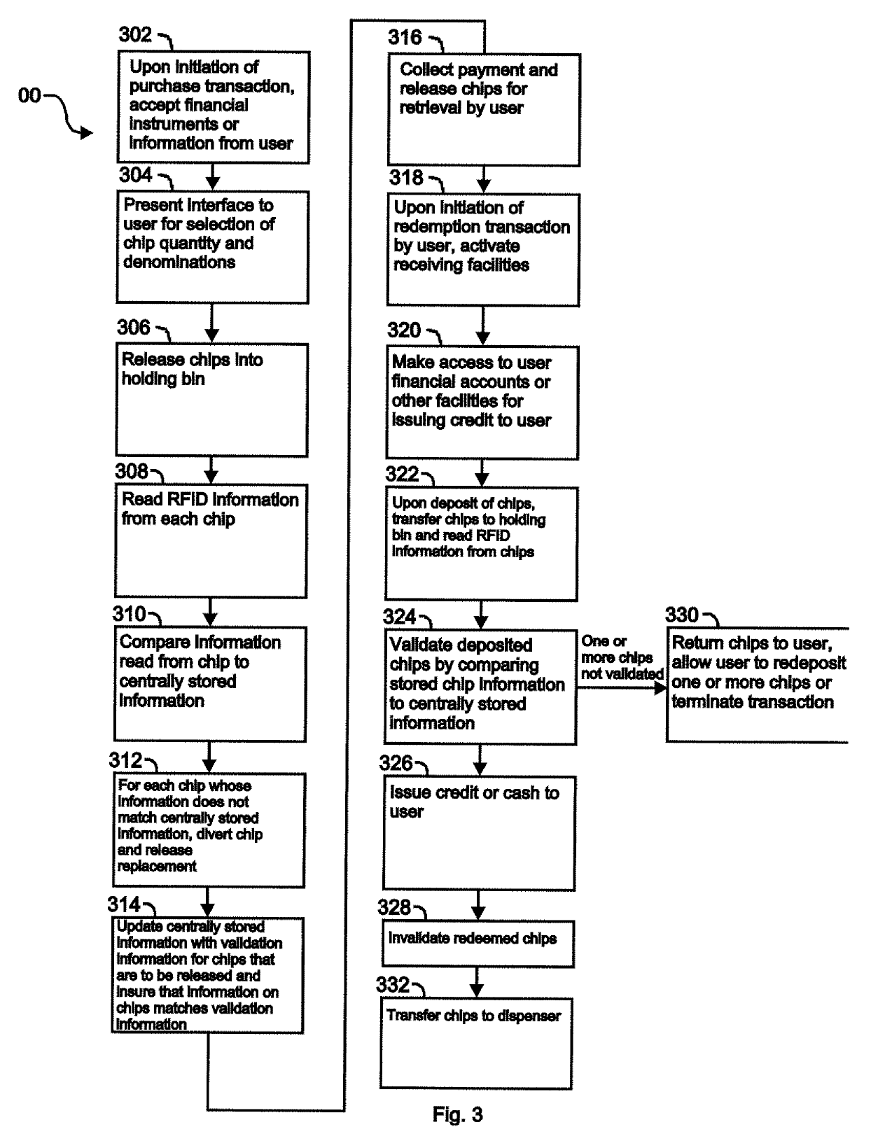

FIG. 3 illustrates a process 300 of gaming chip dispensing and redemption according to an aspect of the present invention. The process 300 may suitably be carried out using a terminal similar to the terminal 100 of FIG. 1. At step 302, upon initiation by a patron of a chip dispensing transaction, financial information or instruments are accepted from the patron for purchase of the chips. At step 304, the user is presented with an interface, such as a display on touchscreen display 112, allowing the selection of the quantity and denomination of the chips desired. At step 306, upon selection by the user, chips are released into a holding bin. At step 308, as chips are being delivered to the holding bin, or after the desired chips have been released to the holding bin, information stored in each chip being delivered for redemption is read by an RFID reader/writer. The information read may suitably include a unique chip identifier, chip denomination, and information indicating chip validity or invalidity, such as an authenticator code. At step 310, information read from each chip is compared to centrally stored information associated with the chip to confirm that the information stored in the chip matches the centrally stored information. If the information stored in a chip does not match centrally stored information, the process proceeds to step 312, the chip is diverted to a holding chamber and a replacement chip is released and examined. At step 314, if validation information is to be loaded into chips at the time they are dispensed, the centrally stored information is updated with a valid authenticator code for each chip to be dispensed and the authenticator code is written to the chip. At step 316, collection is made using cash deposits or financial information received from the user, the chips to be dispensed are delivered to a bin for retrieval by the user, and any excess deposits are refunded.

At step 318, upon indication by a user that chips are to be redeemed, chip receiving facilities, such as a receiving slot or a receiving bin are activated to allow deposit of chips by the user. At step 320, upon provision of identification information such as financial information by the user, access is made to the user's stored value account or financial account in order to prepare for a deposit to the account. At step 322, upon deposit of one or more chips by the user, information stored in each chip is delivered to a holding bin and read using an RFID reader. Deposit may include depositing a single chip at a time, in which case the chip may be read as it is traveling to the holding bin, or depositing a plurality of chips, in which case the plurality of chips may be delivered to the holding bin for reading. Once a chip has been read, the process proceeds to step 324 and the deposited chips are validated, suitably by retrieving corresponding information from a central repository and examining the information read from the chip to insure that chip identification information, denomination information, and other information indicating a chip's identity, value, and validity, such as an authenticator code indicating that the chip is valid for redemption. If one or more chips cannot be validated, the process skips to step 330 and chips that are not validated, or alternatively all chips, are returned to the user and the user is allowed to redeposit chips or to terminate the transaction. If all chips are valid, the process proceeds to step 326 and appropriate value is given to the user for redemption of the chips, such as through dispensing of cash or a deposit to a financial account or stored value instrument of the user.

At step 328, the chips that have been redeemed are invalidated. Such invalidation may take the form of updating the database 140 so as to amend the record for each chip to remove or other invalidate the authenticator code for the chip or to otherwise indicate that the chip is not valid for redemption. The chip, or another chip storing identical information, such as a fraudulently copied chip, will not be able to be redeemed until the database 140 is updated, for example, by adding a new and valid authenticator code and writing the new code to the chip.

If a fraudulent copy of a chip is redeemed, the redemption of that chip will result in invalidation of the genuine chip. If the genuine chip is then submitted for redemption, it will not be able to be automatically redeemed and an investigation can be performed to determine whether a fraudulent transaction has transpired. Because the database 140 is capable of storing a record of transactions and movements involving the chip, the terminal to which each chip has been submitted for redemption can be determined and if a duplicate redemption attempt is detected, the terminal can be opened immediately and the chip can be removed and examined. If a patron submits a chip with identical stored information, the patron can be questioned about the existence of the duplicate. At step 332, performed if deposited chips are to be made available for dispensing, deposited chips are sorted and transferred to a dispensing mechanism in proper order to be dispensed.

While the present invention is disclosed in the context of a presently preferred embodiment, it will be recognized that a wide variety of implementations may be employed by persons of ordinary skill in the art consistent with the above discussion and the claims which follow below.

We claim:

1. A self service terminal for conducting gaming chip transactions, comprising:
a radio frequency identification (RFID) reader for reading information stored in an RFID tag embedded in a gaining chip; and
a processor for receiving the RFID information read by the chip and using the RFID information to identify the chip as valid, the processor being operative to compare the RFID information read from the chip against centrally stored RFID information associated with the chip and to dispense or redeem a chip as appropriate if the comparison with the information read from the chip against the centrally stored information indicates that the chip is valid.

2. The terminal of claim 1, wherein comparing the RFID information read from the chip against centrally stored information includes comparing a stored unique identifier stored in the chip and denomination information stored in the chip against centrally stored identifier and denomination information.

3. The terminal of claim 2, wherein the information stored in the chip and associated with the chip in the centrally stored information includes an authenticator code and wherein the authenticator code is validated before the chip is issued to a patron and invalidated after the chip is redeemed by the patron, and wherein a chip is determined to be invalid if an authenticator code stored in the chip does not match a valid centrally stored authenticator code associated with the chip.

4. The terminal of claim 1, wherein the terminal comprises a bin for deposit by a patron of a plurality of chips for redemption and wherein the RFID reader is operative to read each chip in the bin and the processor is operative to accept the chips for redemption if all chips deposited are determined to be valid.

5. The terminal of claim 4, wherein the processor is operative to direct return of the chips to the patron if one or more chips deposited is determined to be invalid and to direct the patron to deposit one chip at a time for redemption if desired.

6. The terminal of claim 1, comprising two or more RFID readers, with one reader reading information from chips that are to be dispensed and one reader reading information from chips that are to be redeemed.

7. The terminal of claim 1, further comprising a camera for capturing images of chips and wherein a chip is accepted for redemption only if the captured image information conforms to RFID information read from the chip.

8. The terminal of claim 7, further comprising a scale for weighing chips and wherein a chip is accepted for redemption only if the weight of a chip conforms to stored weight information for the chip.

9. The terminal of claim 1, wherein chips accepted for redemption are chips accepted for redemption are made available for dispensing.

10. A method of managing self service gaming chip transactions, comprising the steps of:
reading information stored in an RFID tag embedded in a chip that is the subject of a pending transaction;
comparing the information stored in the RFID tag against centrally stored information associated with the chip; and
completing the transaction only if the information read from the RFID tag matches the centrally stored information.

11. The method of claim 10, wherein the transaction comprises a redemption transaction.

12. The method of claim 10, wherein the transaction comprises a dispensing transaction.

13. The method of claim 10, wherein the information stored in the RFID tag includes an authenticator code associated with the chip and wherein completing the transaction includes insuring that the authenticator code is valid before delivery to a patron for a dispensing transaction.

14. The method of claim 13, wherein completing the transaction comprises confirming that the authenticator code for a chip submitted for redemption is valid before the chip is accepted for redemption and further comprises invalidating the authenticator code once the chip has been accepted for redemption.

15. The method of claim 10, further comprising examining imaging information for a chip and completing the transaction only if the imaging information for the chip conforms to stored RFID information associated with the chip.

16. The method of claim 10, further comprising examining weight information for a chip and completing the transaction only if the weight information for the chip conforms to stored RFID information associated with the chip.

17. The method of claim 11, wherein reading information stored in an RFID tag comprises reading information from a plurality of RFID tags embedded in chips that are simultaneously submitted for redemption, and wherein the transaction is completed only if the stored information read from each chip that is simultaneously submitted matches centrally stored information for that chip.

18. The method of claim 10, further comprising a step of making a chip available for dispensing once the chip has been accepted for redemption.
